(19) United States
(12) Patent Application Publication
(10) Pub. No.: US 2005/0185557 A1
(43) Pub. Date: Aug. 25, 2005

(54) Reproducing apparatus

(75) Inventor: Keita Inakura, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 11/050,328

(22) Filed: Feb. 3, 2005

(30) Foreign Application Priority Data
Feb. 20, 2004 (JP) 2004-044725

(51) Int. Cl. G11B 7/0055

(52) U.S. Cl. 369/53.39; 369/30.05; 369/47.13

(57) ABSTRACT

A reproducing apparatus includes a reproducing unit for reproducing information data recorded on a recording medium and a management unit for detecting a stop position where a reproduction is stopped in the information data and for deleting a data section from the beginning to the stop position in the information data from the recording medium.

### BACKGROUND OF THE INVENTION

1. Field of the Invention

The present invention relates to a reproducing apparatus. In particular, it relates to deletion processing of information data recorded on a recording medium.

2. Description of the Related Art

Apparatuses for recording image data and sound data in digital form on random access media, such as hard disks and digital versatile disks (DVDs), have been widely used in recent years. Unlike videocassette recorders (VCRs), such a disk recorder enables a user to reproduce an image of a desired program from a desired position without cumbersome operations such as video cassette changes and videotape rewinding. The resume function, which allows a user to resume reproducing a recorded program from where the reproduction left off, has become common (see, for example, Japanese Patent Laid-Open No. 2002-112201).

Some apparatuses have a simple edit function, such as partial deletion of data of a program stored on a disk or storing data as one file by combining a plurality of programs.

Even though a disk medium has an increased storage capacity of several tens of gigabytes to one hundred and several tens of gigabytes, data of many programs, each having a large amount of information, is unable to fit on a single disk.

In such a case, it is necessary to increase the amount of storage capacity available on the disk by deleting data of recorded programs.

To this end, the user must select a program to be deleted by individually viewing programs recorded on the disk. This process is an exhausting task.

### SUMMARY OF THE INVENTION

The present invention is directed to a reproducing apparatus, a recording apparatus, and a method of reproducing image files.

The present invention is capable of increasing the amount of storage available on a disk by deleting unnecessary data through simple operations.

According to one aspect of the present invention, a reproducing apparatus includes a reproducing unit configured to reproduce information data recorded on a recording medium, and a management unit configured to detect a stop position where reproduction is stopped in the information data recorded on the recording medium and to delete from the recording medium a data section of the information data from a beginning position to the stop position.

In another aspect, a recording apparatus includes a recording and reproducing unit configured to record information data to a recording medium and to reproduce information data recorded on the recording medium; a producing unit configured to detect a stop position where reproduction stopped in the information data recorded on the recording medium, and to produce compressed information data in which a data section, from a beginning position to the stop position in the information data, is reduced in size; and a control unit configured to delete from the recording medium the data section from the beginning position to the stop position in the information data, and to control the recording and reproducing unit to record the compressed information data produced by the producing unit.

In yet another aspect, a method for reproducing a plurality of image files, each file including encoded moving image data, from a recording medium, the method includes detecting a moving image data portion that is already viewed with respect to each of the plurality of image files; and deleting the viewed moving image data portion with respect to each of the plurality of image files from the recording medium.

Further features and advantages of the present invention will become apparent from the following description of exemplary embodiments with reference to the attached drawings.

### BRIEF DESCRIPTION OF THE DRAWINGS

FIG. 1 is a block diagram showing the structure of a disk recorder according to one embodiment of the present invention.

FIG. 2 is a perspective view of an optical disk used in the disk recorder according to the embodiment of the present invention.

FIG. 3 shows an example of the directory structure on a disk.

FIG. 4 shows recording times of individual recording data files.

FIG. 5 shows an example of a position-information list.

FIG. 6 is a flowchart of preparation of the position-information list.

FIG. 7 shows another example of the position-information list.

FIG. 8 is a flowchart of processing for global partial-deletion.

FIG. 9 is a flowchart of processing for partial recompression.

FIG. 10 shows the position-information list after the processing for partial recompression.

FIG. 11 shows how recorded data sets are processed during the processing for partial recompression.

### DESCRIPTION OF THE EMBODIMENTS

The embodiments of the present invention are described below with reference to the drawings.

According to this embodiment, a disk recorder to which the present invention is applied can record and reproduce digital image data on and from a DVD-RAM disk.

First, an optical disk used in the disk recorder of this embodiment is described.

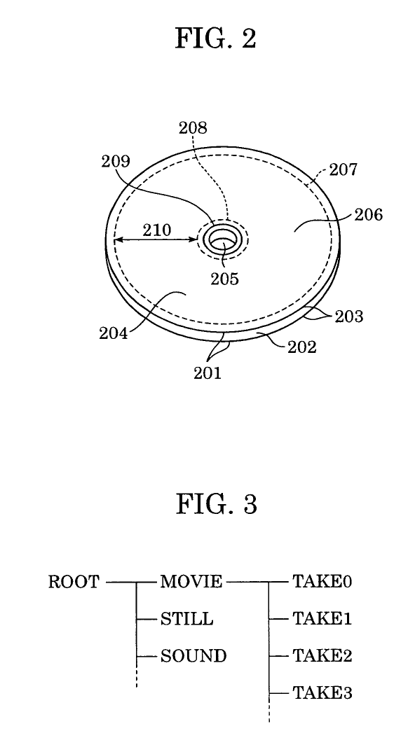

FIG. 2 is a perspective view of the optical disk. In FIG. 2, the optical disk includes a pair of transparent substrates 201, each including a recording layer 202, bonded with a bonding layer 203 disposed therebetween. Each of the transparent substrates 201 has a thickness of about 0.6 mm and is formed of polycarbonate. The bonding layer 203 has, for example, a thickness of about 40 μm and is formed of ultraviolet curing resin. The transparent substrates 201 are bonded together so that the recording layers 202 face each other with the bonding layer 203 therebetween, realizing the large-capacity optical disk with a thickness of about 1.2 mm. The optical disk has a central hole 205, a clamp area 209, an information area 210, a lead-out area 207, a lead-in area 208, and a data-recording area 204. In each of the recording layers in the information area 210, a spiral recording track is arranged continuously. The continuous track is divided into a plurality of serial-numbered physical sectors. One sector serves as a unit of recording.

In this embodiment, such an optical disk is accommodated in a cartridge and is then inserted into the disk recorder. Specifically, a DVD-RAM disk D accommodated in the cartridge is placed into an apparatus for recording and reproducing data of a disk by means of a placement mechanism (not shown), and the cartridge is then ejected by means of an ejection mechanism (not shown), thus leaving only the optical disk D in place within the apparatus. The data-recording track of each of the recording layers 202 is divided into a plurality of logical sectors (one sector serving as a minimum unit of recording) having a predetermined capacity of storage, so that data is recorded in units of these logical sectors. The storage capacity of one logical sector is set at about 2048 bytes, which is equal to the length of packed data.

Next, a file structure in the optical disk is described.

FIG. 3 shows an example of a directory structure. The optical disk deals with video data, still-picture data, sound data, and the like. Therefore, as shown in FIG. 3, the directory structure has a video-information data directory (“MOVIE”), a still-picture data directory (“STILL”), and a sound data directory (“SOUND”) under the root directory.

In this embodiment, in order that the relations between processing of partial deletion and re-encoding with division and data files, all of which are described later, are described using video information as an example, the directory “MOVIE” is opened. Under the directory “MOVIE”, video information files, such as “TAKE0”, “TAKE1”, “TAKE2”, and the like, are created, as shown in FIG. 3. The names of these directories and files, like “MOVIE” and “TAKE0”, and the types thereof are cited merely by way of example and without limitation.

The video information files are moving images recorded with, for example, digital camcorders, DVD players/recorders, or the like.

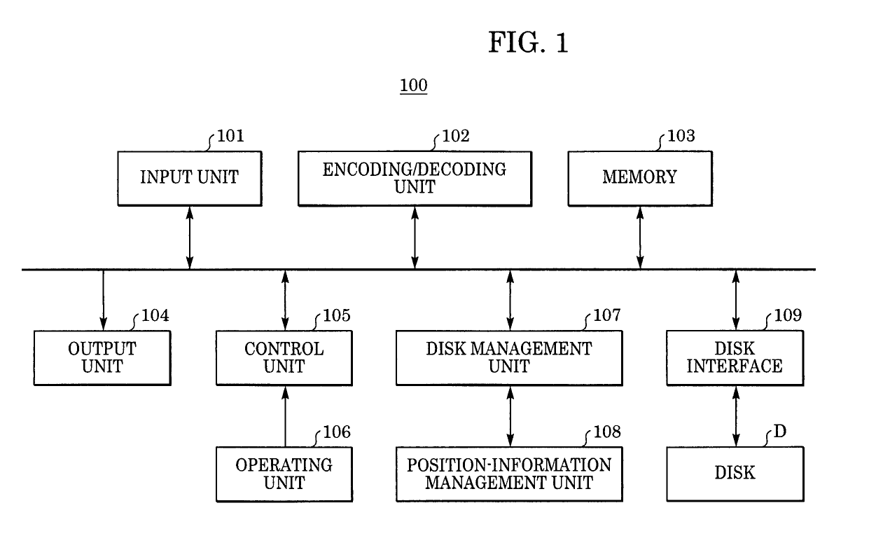

FIG. 1 illustrates the structure of a disk recorder 100 for recording and reproducing digital image data on and from the disk D shown in FIG. 2.

In FIG. 1, the disk recorder 100 includes an input unit 101, including a tuner and an antenna system, for receiving a telecast on a designated channel and outputting it as digital image and sound data; an encoding/decoding unit 102 for encoding and decoding the image and sound data in moving picture experts group (MPEG) format; a memory 103 used in processing at each unit; an output unit 104 for outputting data input from the input unit 101 or data reproduced from the disk D to an external device, such as a monitor or the like; a control unit 105 for controlling each unit; an operating unit 106, including various switches, such as a power switch, a recording switch, a playback (reproduction) switch, and a partial-deletion switch; a disk management unit 107 for managing files and the like recorded on the disk D in accordance with instructions to record, reproduce, and delete data with respect to the disk D; a position-information management unit 108 for managing a stop position where a reproduction of each file (program) recorded on the disk D is stopped; and a disk interface 109 for recording and reproducing various data on and from the disk D.

Record processing of the disk recorder 100 shown in FIG. 1 is described below.

Upon receipt of instructions to start recording provided from the operating unit 106, the control unit 105 controls the encoding/decoding unit 102 and the disk interface 109 so as to start recording. Specifically, the encoding/decoding unit 102 encodes image and sound data input from the input unit 101 so that the data satisfies a data rate specified with the operating unit 106. The disk interface 109 records the data encoded by the encoding/decoding unit 102 on the disk D. At this time, the recording location is managed by the disk management unit 107. When instructions to stop recording is provided, the disk interface 109 stops recording the data on the disk D, and the disk management unit 107 manages a series of data from the beginning of recording to the stop as a single file and outputs management data required for being stored as a file to the disk interface 109 to record the management data on the disk D.

Next, reproduction processing is described.

When a program to be reproduced is selected from a plurality of programs recorded on the disk D by means of the operating unit 106 and instructions to start reproducing is sent therefrom, the control unit 105 provides the disk management unit 107 and the disk interface 109 with instructions to start reproducing the selected file.

The disk management unit 107 informs the disk interface 109 of the recording location where the selected file is recorded. The disk interface 109 reproduces data of the selected file from the disk D. The encoding/decoding unit 102 decodes the data of the reproduced file and outputs it to the output unit 104. The output unit 104 outputs the decoded image and sound data to the external device.

When instructions to stop reproducing is supplied in such a state, the control unit 105 outputs instructions to stop reproducing to the disk management unit 107 and the disk interface 109. In response to the instructions, the disk management unit 107 detects an elapsed time since the beginning of the file in reproduction and sends it to the position-information management unit 108. The position-information management unit 108 manages information on stop positions in units of files recorded on the disk D, as described later. The disk interface 109 stops reproducing data from the disk D.

Next, a position-information list managed by the position-information management unit 108 is described.

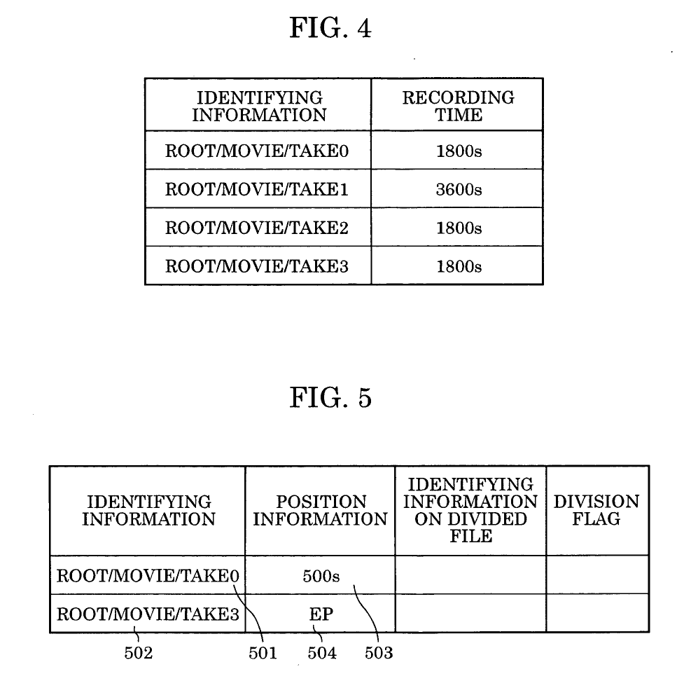

FIG. 4 shows the recording times for the moving-image files “TAKE0”, “TAKE1”, “TAKE2”, and “TAKE3” recorded on the disk D. The identifying information as shown in FIG. 4 represents a path to each file. The recording time for each of the files “TAKE0”, “TAKE2”, and “TAKE3” is 1800 seconds (30 minutes), and that for the file “TAKE1” is 3600 seconds (60 minutes).

FIG. 5 illustrates an example of the position-information list managed by the position-information management unit 108, showing identifying information 501 and 502 for files. Position information 503 represents a stop position of a file having a path “ROOT/MOVIE/TAKE0” and indicates 500 seconds. Position information 504 represents a stop position of a file having a path “ROOT/MOVIE/TAKE3” and indicates “EP”. The term “EP” herein stands for end point and means that viewing up to the end of a file is completed. The term “viewing” used in the specification is applied not only to watching but also to listening.

Identifying information on a divided file is used for identifying a divided and re-encoded video file, which is separated from a video file indicated by an original identifying information entry and re-encoded in processing of re-encoding with division, which is described later. A value of “division flag” is set at one only for a divided video file that is realized by the processing of re-encoding with division.

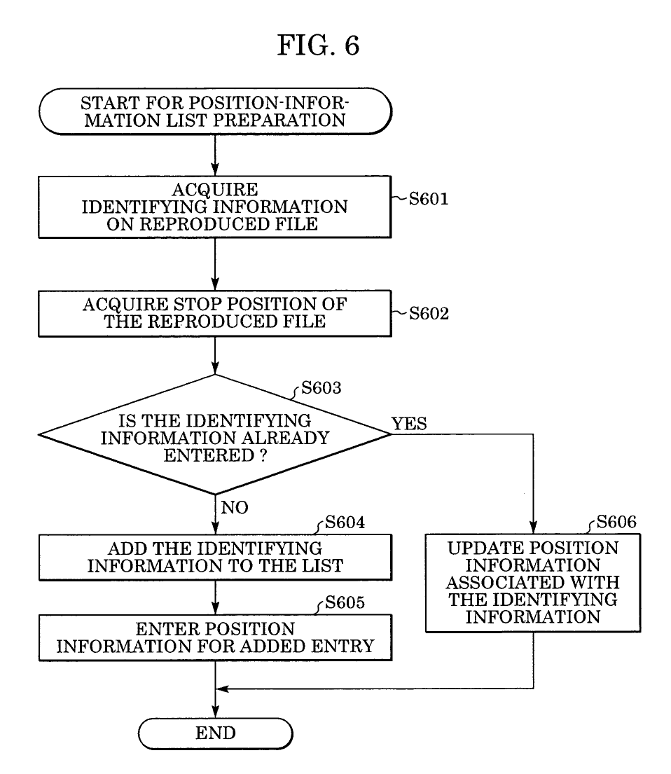

Next, a procedure of a position-information list preparation performed by the position-information management unit 108 and accompanied with an operation of stopping reproduction is described with reference to a flowchart shown in FIG. 6. The explanation is described using a case in which a reproduction of a file indicated by the identifying information “ROOT/MOVIE/TAKE1” in the position-information list shown in FIG. 5 is stopped at a position where 2000 seconds have elapsed from the beginning of the file as an example.

As described above, when the instructions to stop reproducing is supplied, the disk management unit 107 provides the position-information management unit 108 with identifying information on the file in reproduction and information on an elapsed time from the beginning.

Therefore, the position-information management unit 108 acquires the identifying information and the information on the elapsed time from the disk management unit 107 (steps S601 and S602). In this case, the identifying information indicates “ROOT/MOVIE/TAKE1” and the position information representing the elapsed time indicates “2000s”. If the file is reproduced up to the end, the position information will indicate “EP”, which represents that the file is entirely reproduced.

The position-information management unit 108 then searches a stored position-information list, which is previously prepared, and determines whether the acquired identifying information (in this case, “ROOT/MOVIE/TAKE1”) is already entered (step S603).

As shown in FIG. 5, the position-information list does not contain the identifying information “ROOT/MOVIE/TAKE1”. Therefore, the entry for the identifying information “ROOT/MOVIE/TAKE1” is added to the position-information list (step S604). Then, the position information “2000s” acquired in step S602 is entered as position information for the added entry (step S605). The processing for the position-information list preparation is completed.

In step S603, in the case that the acquired identifying information is already entered in the list, the value of the position information for the identifying information “ROOT/MOVIE/TAKE1” is changed to “2000s” (step S606). Then, the processing for the position-information list preparation is completed.

At this time, if the value of the position information associated with the identifying information “ROOT/MOVIE/TAKE1”, which is already entered, is larger than the value of the acquired position information, i.e., the original position information indicates a rearward position to a position indicated by the acquired position information, the original position information may be unchanged in order to avoid reverse operation due to accidental reproduction.

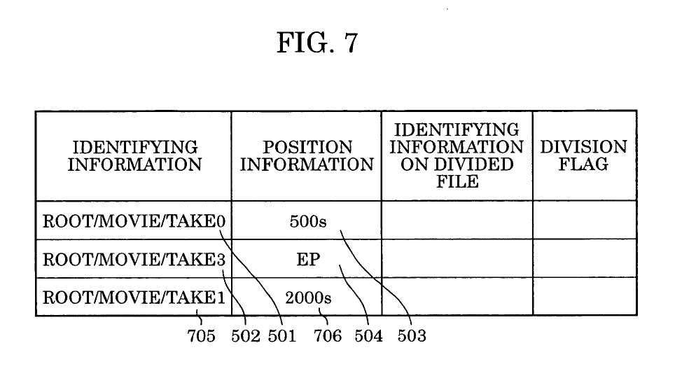

The position-information list prepared through the procedure described above is shown in FIG. 7. The identifying information “ROOT/MOVIE/TAKE1” is added in an entry 705, and the value “2000s” is entered as the position information associated with the identifying information “ROOT/MOVIE/TAKE1” in an entry 706. In FIG. 7, the same reference numerals are used in the same parts as in FIG. 5.

Next, reproduction processing using the position-information list prepared in such a manner when the resume function works is described.

When a file to be reproduced is selected by means of the operating unit 106, the control unit 105 outputs information on the selected file to the disk management unit 107. The disk management unit 107 sends information indicating the name of the selected file to the position-information management unit 108. The position-information management unit 108 searches the position-information list for an entry of identifying information corresponding to the name sent from the disk management unit 107. If the entry of the identifying information is found in the list, the position-information management unit 108 sends position information associated with the identifying information to the disk management unit 107. If not found, the position-information management unit 108 sends the result to the disk management unit 107.

If receiving the position information indicating a stop position from the position-information management unit 108, the disk management unit 107 sends the position information to the disk interface 109. If not receiving, the position-information management unit 108 sends information indicating the position of the beginning of the selected file to the disk interface 109. If receiving the position information indicating the stop position from the disk management unit 107, the disk interface 109 starts reproducing data of the selected file from the stop position. If receiving the information indicating the beginning position, the disk interface 109 starts reproducing data of the selected file from the beginning.

In this case, when the position-information management unit 108 detects the position information indicating a stop position of the selected file, the reproduction resumes the selected file from the stop position. Even when the position-information management unit 108 detects the position information indicating a stop position of the selected file, a user may select the indicated stop position or the beginning of the file for starting the reproduction.

Next, global partial-deletion processing using the position-information list prepared in such a manner is described. According to this global partial-deletion processing, a data section that is already reproduced from the disk D is deleted automatically and globally.

The data deletion in this embodiment is described.

In this embodiment, the disk management unit 107 manages data recorded on the disk D. Specifically, the disk management unit 107 controls recording and reproducing data on and from the disk D using management information indicating recording locations, names, sizes, directory structures, and the like regarding files recorded on the disk D. The data deletion from a disk is realized by rewriting a status at a selected address (sector) on the disk from a recording status to an unrecorded status, not by actually rewriting data recorded on the disk. Similarly, dividing a single file into a plurality of files and combining a plurality of files together are realized by rewriting the contents of this management information.

Then, the disk interface 109 reads the management information from the disk D in response to placement of the disk D and sends the management information to the position-information information management unit 108. The position-information management unit 108 stores the management information in an internal register and updates the contents of the management information on the register. The position-information management unit 108 sends the updated management information at a time of ejecting the disk or at another predetermined time to the disk interface 109, so that the updated management information is stored in a predetermined area for storing management information.

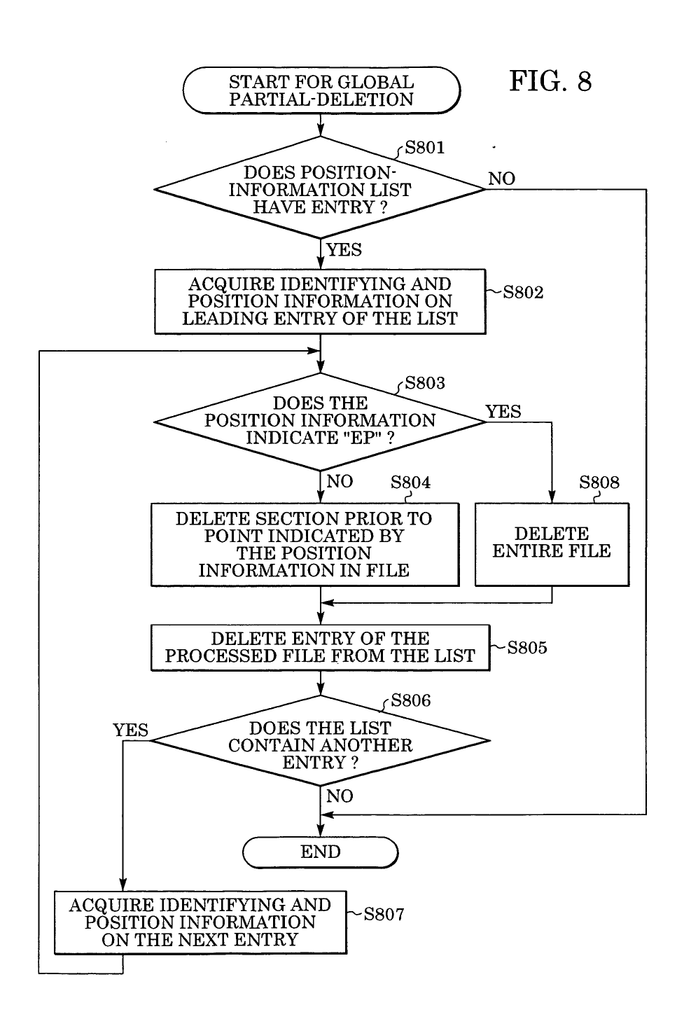

FIG. 8 is a flowchart of processing for global partial-deletion performed by the disk management unit 107. The processing begins in response to instructions to perform global partial-deletion provided from the operating unit 106.

First, it is determined whether the position-information list stored in the position-information management unit 108 contains an entry (step S801). If the list is determined to contain no entry, the processing exits.

If the list is determined to contain an entry or entries, identifying information and position information for the leading entry are acquired (step S802). In FIG. 7, the identifying information indicates “ROOT/MOVIE/TAKE0” and the position information 503 indicates “500s” for the leading entry.

Next, it is determined whether the acquired position information indicates “EP” (step S803). If so, the corresponding file is determined to be already viewed completely. Then, the entire file is deleted (step S808) and the processing goes to step S805.

If it is determined that the position information does not indicate “EP”, a data section prior to the point indicated by the acquired position information “500s” in the file identified by the acquired identifying information “ROOT/MOVIE/TAKE0” is deleted (step S804), and the entry of the processed file is deleted from the list (step S805). Then, it is determined whether the list contains another entry (step S806). If so, identifying information and position information on the next entry are acquired (step S807) and the processing goes back to step S803.

The disk management unit 107 changes the contents of management information for each file, i.e., the size, the leading address, and the like in accordance with a series of steps of partial deletion processing described above.

As described above, according to this embodiment, position information indicating a stop position where a reproduction is stopped for each file recorded on the disk D is stored, and a data section prior to the stop position with respect to each file is automatically deleted in response to instructions to perform global partial-deletion. Therefore, only a data section that is already viewed by a user with respect to each file is readily deleted, thus increasing the amount of storage available on a disk.

Accordingly, even when there is not enough storage space on a disk, a user does not have to view files recorded on the disk one by one and select a data section that is already viewed in order to delete the data section.

Next, partial recompression processing using the position-information list shown in FIGS. 5 and 7 is described. The global partial-deletion processing described above deletes a data section prior to a stop position where a reproduction is stopped. On the other hand, according to the partial recompression processing, a file is divided so that a data section prior to the stop position is separated from the file and the separated data section is entered as a new file, and this new file (hereinafter referred to as “divided file”) is re-encoded at a compression rate higher than that used in recording, instead of deletion of a data section, in order to increase the amount of storage available on a disk.

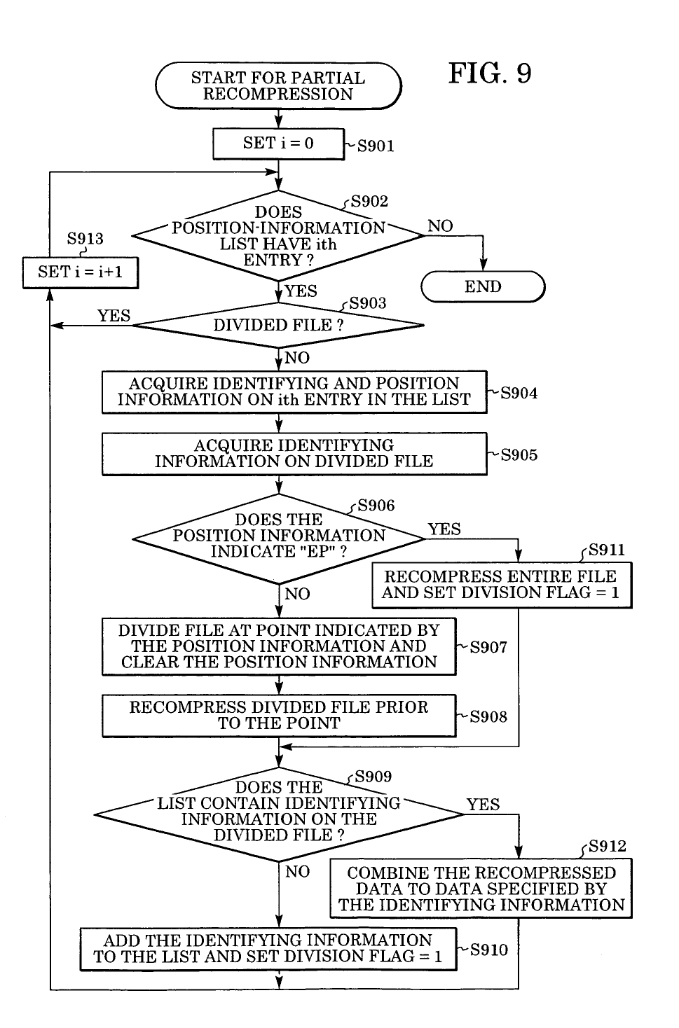

FIG. 9 is a flowchart of the processing for partial recompression performed by the disk management unit 107 and the control unit 105. The processing begins in response to instructions to carry out partial recompression provided from the operating unit 106.

First, a value, i, representing the number of an entry to be processed in the position-information list is set at zero (step S901). Next, it is determined whether the position-information list contains an ith video-information entry (step S902). If the list contains no ith video-information entry, the processing of partial recompression exits.

If the list contains the ith video-information entry, then it is determined whether a division flag for the entry is one in order to determine whether a file corresponding to the entry is a divided file, which is newly entered after being divided (step S903). If the division flag is one, i.e., the file is a divided file, one is added to the value i (step S913), then the processing goes back to step S902.

If the file is not a divided file, identifying information and position information on the ith entry in the position-information list are acquired (step S904). For example, in the position-information list shown in FIGS. 5 and 7, in the case that i=0, the identifying information indicates “ROOT/MOVIE/TAKE0” and the position information indicates “500s”; in the case that i=1, the identifying information indicates “ROOT/MOVIE/TAKE3” and the position information indicates “EP”. Then, identifying information on a divided file regarding the ith entry is acquired (step S905). In FIG. 7, the position-information list is prepared before division processing, and therefore, such identifying information on a divided file is not entered.

Next, it is determined whether the acquired position information on the ith entry in the position-information list indicates “EP” (step S906). If the position information indicates “EP”, like in the case that i=1 in the position-information list shown in FIG. 7, entire image data of a file corresponding to the identifying information “ROOT/MOVIE/TAKE3” is recompressed so as to reduce its size, then the division flag is set at one (step S911).

If the position information associated with the identifying information “ROOT/MOVIE/TAKE0” does not indicate “EP”, like in the case that i=0 in the position-information list shown in FIG. 7, the file is divided at the point indicated by the position information, then the position information is cleared (step S907). At this time, the identifying information on a file of a data section subsequent to the stop point remains unchanged, and that on a file prior to the stop point is newly entered. For example, in the case that i=0 in the list shown in FIG. 7, the subsequent file has unchanged identifying information “ROOT/MOVIE/TAKE0”, and the divided file, which is data prior to the stop point, has the new identifying information “ROOT/MOVIE/TAKE4”. Image data of the divided file is recompressed so as to reduce its size (step S908).

Recompression processing is described.

For recompression processing, at step S908 or S911, the disk management unit 107 controls the disk interface 109 to read data of a selected file. The disk management unit 107 controls the encoding/decoding unit 102 to detect a compression rate of image data included in the file, decodes read image data temporarily, and encodes the read image data at a predetermined compression rate higher than the detected compression rate. The disk management unit 107 controls the disk interface 109 to record the recompressed image data on the disk D.

The disk management unit 107 rewrites the contents of management information so that data before being subjected to recompression processing is deleted from the disk D when produced corresponding recompressed data is newly recorded. At this time, a file of the newly-recorded recompressed data is named in order to associate identifying information added to the position-information list with the file.

After recompression is performed, as described above, it is determined whether the position-information list contains the identifying information on the divided file, which is acquired at step 905 (step S909). If the list does not contain the acquired identifying information, an entry for the identifying information is added to the position-information list and “EP” is entered as position information for the entry (step S910). For example, in FIG. 7, in the case that i=0, a new identifying information “ROOT/MOVIE/TAKE4” is assigned to a divided file, which is prior to the point indicated by the position information, so that the identifying information “ROOT/MOVIE/TAKE4” is entered in the position-information list and “EP” is entered as position information associated therewith.

In step S909, if the identifying information on the divided file is already entered in the position-information list, the recompressed data is combined into a file of data specified by the identifying information on the divided file (step S912).

Then, one is added to the value i, and the processing goes back to step S902.

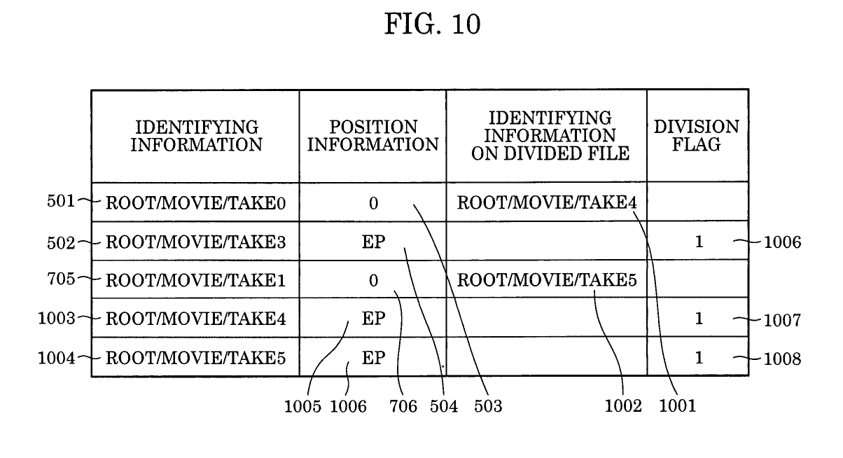

After the partial recompression processing is completed through the procedure described above, the position-information list shown in FIG. 7 is changed to that in FIG. 10.

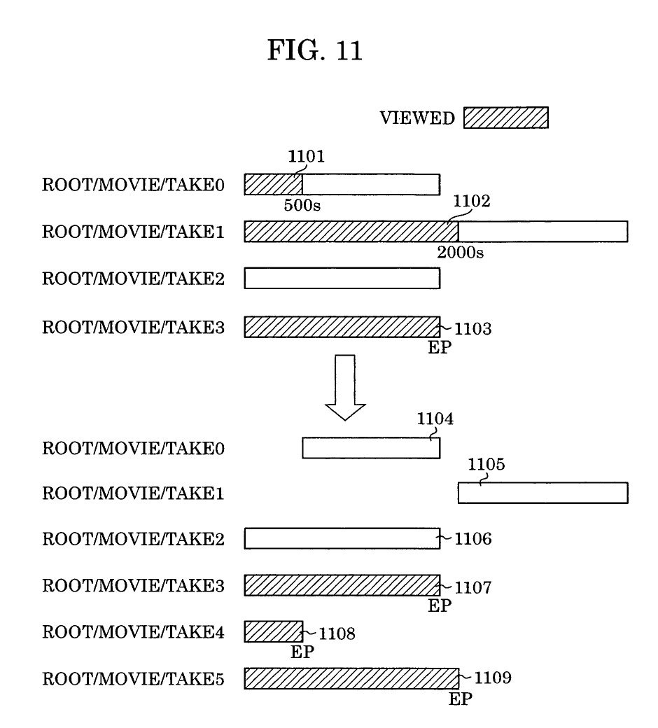

FIG. 11 shows how each file is processed on the disk D during the recompression processing described above.

Specifically, in a file corresponding to the identifying information “ROOT/MOVIE/TAKE0”, a viewed section 1101 is 500 seconds long from the beginning. Therefore, the file is divided at a position of 500 seconds away from the beginning. A file of data of an unviewed section 1104 retains its original identifying information “ROOT/MOVIE/TAKE0”. Data of the viewed section 1101 is reduced in size by being recompressed and is recorded as a new file 1108 identified by identifying information “ROOT/MOVIE/TAKE4”. At this time, the position information 503 for the identifying information “ROOT/MOVIE/TAKE0” is cleared, and the identifying information “ROOT/MOVIE/TAKE4” for its divided file is entered. A new entry of this identifying information “ROOT/MOVIE/TAKE4” is added to the position-information list and “EP” is entered as position information associated with the identifying information “ROOT/MOVIE/TAKE4”. On the other hand, data of a file identified by the identifying information “ROOT/MOVIE/TAKE2” is not reproduced at all, and therefore, this file is not entered in the position-information list. As a result, this file is not subjected to recompression processing.

Data 1103 of a file identified by the identifying information “ROOT/MOVIE/TAKE3” is entirely viewed. Therefore, the entire data is re-encoded and reduced in size, as shown as data 1107, and its division flag is set at one. Like the file identified by the identifying information “ROOT/MOVIE/TAKE0,” a file identified by the identifying information “ROOT/MOVIE/TAKE1” is divided so as to separate a viewed section 1102 from the file. Data of the viewed section 1102 is newly entered as data 1109 identified by new identifying information “ROOT/MOVIE/TAKE5” in the position-information list.

As described above, according to this embodiment, information indicating a stop position where a reproduction is stopped with respect to each file recorded on the disk D is stored, and in response to instructions to perform global partial-recompression, each file is automatically divided at the stop position, and each divided file, which is data prior to the stop position, is recompressed. As a result, data that is already viewed by a user is reduced in size, thus increasing the amount of storage available on the disk.

In this embodiment, file paths are used as identifying information for video information. However, file names or identification numbers under standards for recording media may be used as identifying information as long as video information is uniquely identified by them. As an alternative to division flags, other methods may be used for identifying divided files as long as re-encoded data is identified by them.

Each file on the disk D may be protected against editing processing by instructions sent from the operating unit 106. In this case, global partial-deletion or partial recompression processing is not performed even when instructions to execute such processing are supplied.

Therefore, protected video information is not accidentally deleted or re-encoded even when processing of global partial-deletion or global partial-recompression is executed.

In processing of global partial-deletion or global partial-recompression, data from the beginning to a stop position where a reproduction is stopped is deleted or re-encoded. Alternatively, data from the beginning to a position corresponding to a predetermined time, such as several seconds, before the stop position may be deleted or re-encoded.

As a result, a data segment immediately in front of the stop position remains without being processed. This helps a user recall the contents of data when the user reproduces the data afterward.

In recompression processing, in the case that the size of data of a program that a user intends to record is known in advance and the current available storage space on a disk is insufficient for recording the program, calculating the amount of storage required for recording the program by using a time for the program and a recording data rate (compression rate) set by the user and recompressing only the amount of data being the difference between the current available storage space on the disk and the required storage space so as to reduce its size may be used.

In the above embodiment, the position-information list, as shown in FIGS. 7 and 10, is stored in the register within the position-information management unit 108. Alternatively, the position-information list may be stored on the disk D.

In the above embodiment, the present invention is applied to the disk recorder. The present invention is also applicable to an apparatus for recording and reproducing information data, such as image data and sound data, on a random access medium, such as a semiconductor memory card.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-044725 filed Feb. 20, 2004, which is hereby incorporated by reference herein.

1. A reproducing apparatus comprising:
a reproducing unit configured to reproduce information data recorded on a recording medium; and
a management unit configured to detect a stop position where reproduction is stopped in the information data recorded on the recording medium and to delete from the recording medium a data section of the information data from a beginning position to the stop position.

2. A reproducing apparatus according to claim 1,
wherein the management unit includes a storing unit configured to store position information indicating the stop position in the information data, and
wherein the management unit detects the stop position in the information data on the basis of the position information stored in the storing unit.

3. A reproducing apparatus according to claim 2,
wherein the information data recorded on the recording medium comprises a plurality of data sections, and
wherein the management unit stores the position information of each of the plurality of data sections in the storing unit and deletes from the recording medium the data section from the beginning position to the stop position with respect to each of the plurality of data sections.

4. A reproducing apparatus according to claim 3,
wherein the management unit is configured to prepare a position-information list associating individual information data of the plurality of data sections with individual stop positions thereof in response to an instruction to stop reproducing the information data, and
wherein the management unit deletes the position-information list from the storing unit in accordance with deleting the information data.

5. A reproducing apparatus according to claim 4, further comprising a control unit configured to control the reproducing unit so that, in response to an instruction to start reproducing a data section selected from the plurality of data sections contained in the position-information list, the reproducing unit starts reproducing the selected data section from the stop position indicated by the position information corresponding to the selected data section.

6. A reproducing apparatus according to claim 1, wherein the management unit deletes the information data by changing management information required to manage the information data recorded on the recording medium.

7. A reproducing apparatus according to claim 1,
wherein the management unit detects the stop position in the information data on the basis of position information indicating the stop position, the position information being recorded on the recording medium.

8. A recording apparatus comprising:
a recording and reproducing unit configured to record information data to a recording medium and to reproduce information data recorded on the recording medium;
a producing unit configured to detect a stop position where reproduction stopped in the information data recorded on the recording medium, and to produce compressed information data in which a data section, from a beginning position to the stop position in the information data, is reduced in size; and
a control unit configured to delete from the recording medium the data section from the beginning position to the stop position in the information data, and to control the recording and reproducing unit to record the compressed information data produced by the producing unit.

9. A recording apparatus according to claim 8,
wherein the information data is compressed at a desired compression rate, and
wherein the producing unit produces the compressed information data by compressing the information data at a compression rate higher than the desired compression rate.

10. A recording apparatus according to claim 8, further comprising:
a storing unit configured to store position information indicating the stop position in the information data,
wherein the producing unit detects the stop position in the information data on the basis of the position information stored in the storing unit.

11. A recording apparatus according to claim 10,
wherein the information data recorded on the recording medium includes a plurality of data sections, and
wherein the storing unit stores the position information with respect to each of the plurality of data sections.

12. A recording apparatus according to claim 11,
wherein the producing unit produces the compressed information data with respect to each of the plurality of data sections in the information data to produce a plurality of compressed information data sets, and
wherein the control unit deletes from the recording medium the data section from the beginning position to the stop position with respect to each of the plurality of data sections in the information data, and controls the recording and reproducing unit to record the plurality of compressed information data sets produced by the producing unit on the recording medium.

13. A recording apparatus according to claim 10,
wherein the storing unit stores compression-file identifying information, which identifies the compressed information data produced by the producing unit and the position information on the information data.

14. A recording apparatus according to claim 8,
wherein the information data recorded on the recording medium includes a plurality of data sections, and
wherein the control unit controls the producing unit to produce the compressed information data with respect to at least one data section selected from the plurality of data sections, the selected data section not being protected against data deletion, and controls the recording and reproducing unit to record the produced compressed information data on the recording medium.

15. A recording apparatus according to claim 8,
wherein the recording and reproducing unit records the information data as a single file on the recording medium, and
wherein the control unit divides the information data at the stop position into at least two files in response to instructions to produce the compressed information data, and controls the recording and reproducing unit to record the compressed information data as a new single file on the recording medium.

16. A recording apparatus according to claim 8,
wherein the control unit detects the stop position in the information data in response to instructions to start reproducing the information data, and controls the recording and reproducing unit to reproduce the information data from the stop position.

17. A recording apparatus according to claim 8, further comprising:
a specifying unit configured to specify an amount of storage required to newly record the information data to the recording medium,
wherein the producing unit determines a size of the compressed information data so that, after the data section from the beginning position to the stop position in the information data is deleted from the recording medium and the compressed information data is recorded, the amount of storage available on the recording medium is greater than or equal to the specified amount of storage.

18. A recording apparatus according to claim 8,
wherein the producing unit detects the stop position in the information data on the basis of position information indicating the stop position, the position information being recorded on the recording medium.

19. A recording apparatus according to claim 8,
wherein the stop position lies at a point before a predetermined period from a point corresponding to a reproduction stop instruction.

20. A reproducing apparatus comprising:
a reproducing unit configured to reproduce a plurality of image files, each file including moving image data, from a disk recording medium;
a storing unit configured to store position information indicating a stop position where a reproduction is stopped with respect to each of the plurality of image files;
a control unit configured to detect the stop position with respect to an image file selected from the plurality of image files from the position information stored in the storing unit in response to instructions to start reproducing the selected image file and to control the reproducing unit to start reproducing the selected image file from the detected stop position; and
a management unit configured to delete a data section from the beginning to the stop position with respect to each of the plurality of image files from the disk recording medium on the basis of the position information stored in the storing unit.

21. A recording apparatus comprising:
a reproducing unit configured to reproduce a plurality of image files, each image file including moving image data, from a disk recording medium;
a storing unit configured to store position information indicating a stop position where reproduction is stopped in each of the plurality of image files;
a recording unit configured to record moving image data on the disk recording medium;
a producing unit configured to produce compressed image data in which a moving image data section from a beginning to the stop position of each of the plurality of image files recorded on the disk recording medium is compressed on the basis of the position information stored in the storing unit;
a management unit configured to delete the moving image data section with respect to each of the plurality of image files from the disk recording medium on the basis of the position information stored in the storing unit; and
a control unit configured to detect the stop position with respect to an image file selected from the plurality of image files from the position information stored in the storing unit in response to instructions to start reproducing the selected image file, to control the reproducing unit to start reproducing the selected image file from the detected stop position, and to control the recording unit to record the compressed image data produced by the producing unit in the plurality of image files on the disk recording medium.

22. A reproducing apparatus comprising:
a reproducing unit configured to reproduce a plurality of image files, each file including moving image data, from a recording medium; and
a management unit configured to detect a moving image data portion that is already viewed with respect to each of the plurality of image files and to delete the viewed moving image data portion with respect to each of the plurality of image files from the recording medium.

23. An apparatus according to claim 22,
wherein the management unit includes a storing unit configured to individually store information on the viewed moving image data portion with respect to each of the plurality of image files and deletes the viewed moving image data portion with respect to each of the plurality of image files on the basis of the information indicating the viewed moving image data portion, the information being stored in the storing unit.

24. A method for reproducing a plurality of image files, each file including encoded moving image data, from a recording medium, the method comprising:
detecting a moving image data portion that is already viewed with respect to each of the plurality of image files; and
deleting the viewed moving image data portion with respect to each of the plurality of image files from the recording medium.
